(19) United States
(12) Patent Application Publication
(10) Pub. No.: US 2010/0230878 A1
(43) Pub. Date: Sep. 16, 2010

(54) Suspension Strut With Screw Pot

(75) Inventor: Josef Seidl, Dingolfing (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 12/785,894

(22) Filed: May 24, 2010

Related U.S. Application Data
(63) Continuation of application No. PCT/EP2008/010495, filed on Dec. 11, 2008.

(30) Foreign Application Priority Data
Jan. 17, 2008 (DE) 10 2003 004 887.9

(51) Int. Cl. B60G 15/06; F16F 13/00; B60G 17/02; B60G 11/52

(52) U.S. Cl. 267/220

(57) ABSTRACT

A suspension strut with an elastomer block is provided for a wheel of a vehicle, in particular for a wheel of a motorcycle. The hardness of the elastomer block, which interacts with an additional spring element, can be modified. The spring constant of the elastomer block can be modified by adjusting a screw pot. The screw pot engages externally with the elastomer block. The spring base of the elastomer block may be adjustable.

### CROSS-REFERENCE TO RELATED APPLICATIONS

This application is a continuation of PCT International Application No. PCT/EP2008/010495, filed Dec. 11, 2008, which claims priority under 35 U.S.C. §119 from German Patent Application No. DE 10 2008 004 887.9, filed Jan. 17, 2008, the entire disclosures of which are herein expressly incorporated by reference.

### BACKGROUND AND SUMMARY OF THE INVENTION

The invention relates to a suspension strut for a wheel of a vehicle, in particular a wheel of a motorcycle. A known suspension strut has a damping cylinder, in which a damping piston can be displaced with an outwardly guided piston rod, and a first spring element, which is arranged around the damping cylinder, as well as a second spring element, which is designed as an elastomer block and which exhibits the shape of a hollow cylinder and which is connected in series to the first spring element and is arranged around the cylinder wall of the damping cylinder. The sandwich design composed of the first and second spring element is braced, on the one hand, against the external end of the piston rod and, on the other hand, against a stop element, which is fixed in position on the damping cylinder.

NL 1029266 discloses such a suspension strut. In particular, FIGS. 10 to 12 of NL 1029266 show a suspension strut with a helical spring and an elastomer block, which is connected in series to the spring. The elastomer block is designed such that at least one section of the length of the elastomer block has a cavity in the direction of the outer wall of the cylinder. Then, when the elastomer block is compressed, the material of the elastomer can escape into this cavity. A conical control sleeve can be pushed into the cavity. As a result, depending on the adjustment depth of the control sleeve, the elastomer has increasingly fewer escape possibilities, as a consequence of which its spring hardness increases.

The object of the invention is to provide an improved suspension strut.

The invention achieves this object by providing a suspension strut for a wheel of a vehicle, in particular a motorcycle, having a damping cylinder, in which a damping piston can be displaced with an outwardly guided piston rod, and a first spring element, which is arranged around the damping cylinder, as well as a second spring element, which is designed as an elastomer block and which exhibits the shape of a hollow cylinder and which is connected in series to the first spring element and is arranged around the cylinder wall of the damping cylinder. The sandwich design composed of the first and second spring element is braced, on the one hand, against the external end of the piston rod and, on the other hand, against a stop element, which is fixed in position on the damping cylinder. The elastomer block is arranged in an axially displaceable manner around the wall of the damping cylinder without any immediate space. A screw pot can be moved in the axial direction of the suspension strut over the outer contour of the elastomer block. Advantageous embodiments are described herein.

According to the invention, the elastomer block lies against the outer wall of the damping cylinder. As a result, the elastomer block can be readily positioned and has a defined seat. In the event of compression motions that is, when the elastomer block is compressed, it arches outwards in that its material escapes radially outward. When the introduced force weakens, the elastomer block springs back into its starting position. Hence, it determines together with the first spring element the total spring rate of the system.

However, the screw pot prevents with more or less intensity this arching as a function of the adjustment depth of the screw pot in relation to the elastomer block. The result of this feature is that consequently the spring rate of the elastomer block and, hence, the total spring rate of the system are also changed. If the screw pot covers the whole length of the elastomer block, then it is no longer possible for the elastomer block to arch at all. When this occurs, the elastomer block is virtually inelastic. If at the same time the screw pot strikes against the spring plate between the first and second spring elements, then the second spring element—the elastomer block—is switched off.

The elastomer block is braced against a stop on the cylinder housing. This stop can be securely connected to the cylinder housing, for example, by welding or the like. However, it is also advantageous to make the stop adjustable with respect to the cylinder housing, in the simplest case by way of a self-locking threaded connection. As a result, the elastomer block can be compressed with more or less intensity as early as in the starting state, a feature that in turn changes the spring rate of the elastomer block. In this way the spring characteristic and the prestress of the entire suspension strut system can be changed over a defined range.

In a practical embodiment, the spring plate between the first spring element and the elastomer block has, comparable as above, an adjustable stop for the screw pot. Depending on the vertical adjustment of the stop, the screw pot strikes sooner or later against this stop during a compression movement and consequently switches off the elastomer block as the spring element. Then only the first spring element continues to be effective.

Furthermore, it is advantageous to configure this spring plate as a spring cup with a cup rim, on which can be mounted the aforementioned stop as a function of the layout. In addition, the cup rim can also be used to protect the elastomer block against soiling. Then the screw pot can be guided on the cup rim. Then for this purpose an additional practical embodiment can employ the stop that is connected to the damping cylinder.

It may also be advantageous to be able to exchange the sequence order of the two spring elements. That is, the elastomer block sits on the spring plate, connected to the piston rod, and the second spring element—expediently a helical spring—is braced against the stop of the damping cylinder. This configuration results in additional design tolerances, in particular for the spring plate situated between the two spring elements.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 depicts a first embodiment of a suspension strut according to the invention;

FIG. 2 depicts a second embodiment of a suspension strut according to the invention;

FIG. 3 depicts a third embodiment of a suspension strut according to the invention;

FIG. 4 depicts a fourth embodiment of a suspension strut according to the invention;

FIG. 5 depicts a fifth embodiment of a suspension strut according to the invention; and

FIG. 6 depicts a sixth embodiment of a suspension strut according to the invention.

### DETAILED DESCRIPTION OF THE DRAWINGS

In the Figures, to the extent that the components of the individual embodiments have the same functions, they are largely assigned the same reference numerals, provided that it is deemed to be expedient.

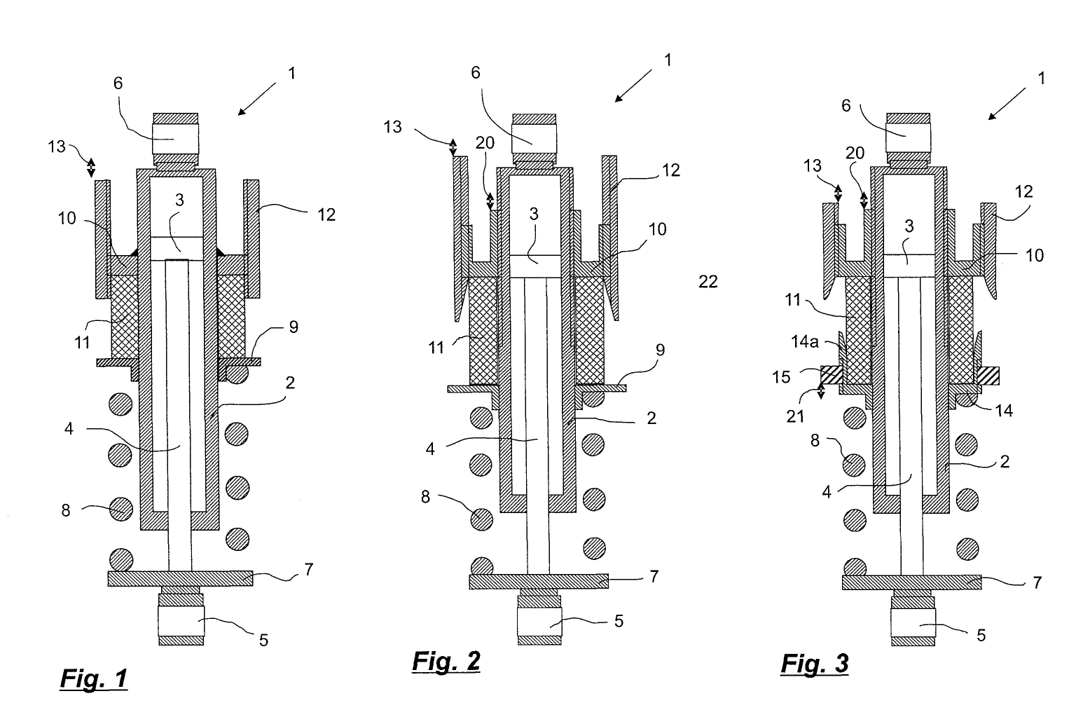

FIG. 1 depicts a suspension strut 1, which is a component of a wheel suspension (not shown in detail) of a wheel of a vehicle, in more precise terms a front or rear wheel of a motorcycle. Such suspension struts are well known so that the image in the drawing is restricted solely to the functional components.

The suspension strut 1 consists of a damping cylinder 2, in which is guided a damping piston 3. An outwardly leading piston rod 4 engages with the damping piston 3. The exposed section of the piston rod 4 has a fixing lug 5 for the vehicle wheel that is to be attached. On the opposite side the damping cylinder 2 is securely mounted on the vehicle chassis with a similar fixing lug 6.

Above its fixing lug 5 and outside the damping cylinder 2, the piston rod 4 has a spring plate 7, on which rests the lower end of a helical spring 8. The helical spring 8 is oriented coaxially with the damping cylinder 2, and its turns are arranged at an adequate distance from the outer wall of the cylinder 2. In addition, the helical spring 8 extends as far as approximately the center of the longitudinal expansion of the damping cylinder 2, where the helical spring is braced against the underside of an additional spring plate 9. This spring plate 9 is in turn, positioned in an axially displaceable manner on the outer wall of the damping cylinder 2.

Between the upper side of the spring plate 9 and a stop 10 an elastomer block 11 is clamped. The elastomer block 11 acts as an additional spring element and, in this manner, is connected in series to the helical spring 8. The elastomer block 11 has the shape of a hollow cylinder and lies with its inner wall against the outer jacket of the damping cylinder 2, but can be displaced relative to the damping cylinder in the axial direction of the suspension strut 1. The stop 10 is mounted on the damping cylinder 2 by welding or with other similar connecting techniques.

During compression of the suspension strut, the helical spring 8 and, owing to said helical spring, the elastomer block 11 are pushed over the axially displaceable spring plate 9. In so doing, the elastomer block escapes radially outwards (not illustrated). During rebound, the elasticity of the elastomer block 11 allows it then to return to the base shape that is shown in FIG. 1.

A screw pot 12 is mounted on the stop 10 in an axially displaceable manner—that is, again in the direction of the longitudinal axis of the suspension strut 1. For this purpose the stop 10 exhibits an external thread, with which a thread, which is provided in the inner wall of the screw pot 12, meshes. The axial displacement option is indicated by an arrow 13. The inside contour of the screw pot 12 is adapted to the outside contour of the elastomer block 11. The screw pot 12 is dimensioned in such a manner that it envelops the elastomer block 11 without a gap or with only a small gap, when the screw pot 12 moves downward.

In FIG. 1, the screw pot 12 is located in an upper position. At the same time it covers the upper section of the elastomer block 11. During a compression phase the elastomer block 11 can escape—as described above—radially outwards in a largely unimpeded manner. If the screw pot 12 moves downwards, it impedes more and more area of the elastomer block 11 from a radially outward formation. The elastomer block 11 becomes harder, and its spring rate increases. In the lower end position of the screw pot 12, the bottom face side of the screw pot 12 strikes against the spring plate 9. As a result, the elastomer block 11 is neutralized or switched off, because now the introduced force is braced directly against the stop 10 via the helical spring 8, the spring plate 9 and the screw pot 12.

According to FIG. 2, a somewhat differently designed screw pot 12 is guided in turn on the outside of a stop 10 that is also modified. The major distinction between the stop 10 in FIG. 2 and the stop according to FIG. 1, is not only its shape but also the fact that it can also be lowered axially and, as a result, can give the elastomer block 11 a more or less large prestress. The displaceability is symbolized by the double arrow 20. The stop 10 is guided over an external thread in the damping cylinder 2.

Moreover, the lower section of the inner wall of the screw pot 12 expands conically outwards. Consequently the elastomer block 11, escaping during compression, is better protected against injuries to its material owing to the lower, outwardly extending edge of the screw pot 12.

In FIG. 3, the spring plate between the helical spring 8 and the elastomer block 11 is expanded to form a spring cup 14 with an upwards pointing cup rim 14a. The cup rim 14a envelops the lower section of the elastomer block 11 and, thus, gives it a secure hold. In addition, the cup rim 14a carries a stop 15 for the screw pot 12. In this case, the stop 15 is axially adjustable by way of a thread on the outer rim of the cup, where said axial adjustment is indicated by a double arrow 21.

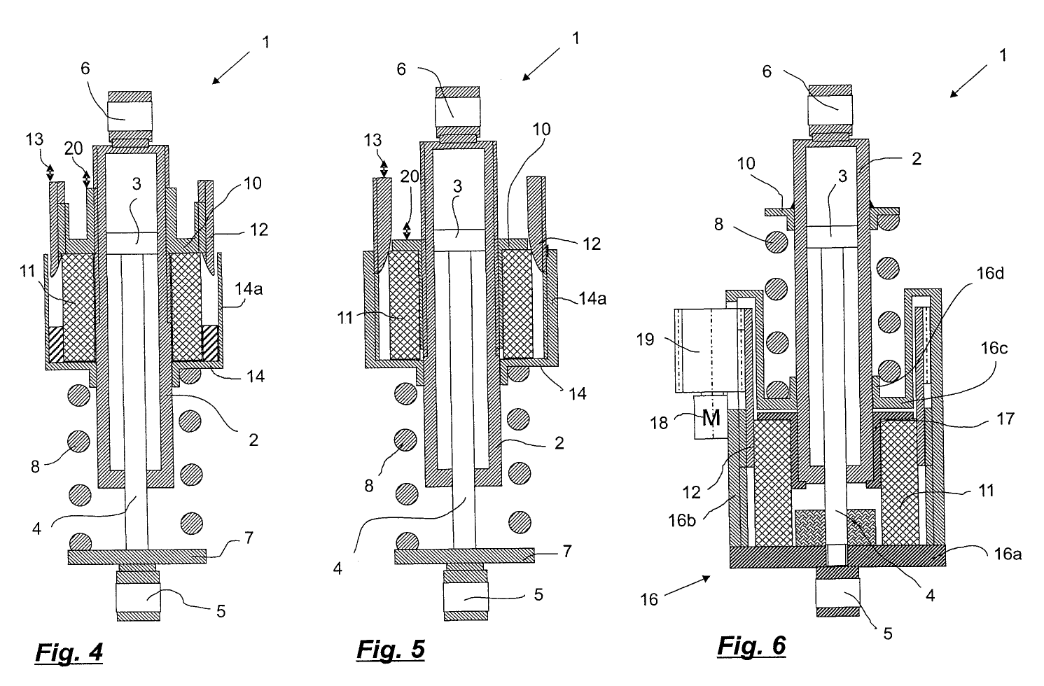

In the embodiment according to FIG. 4, the cup rim 14a of the spring cup 14 is elongated towards the top, so that it covers the entire length of the elastomer block 11. However, the cup rim 14a does not rest against the elastomer block 11, but rather envelops it at a distance. The cavity produced in this way provides space for the screw pot 12, which can be lowered and guided on the stop 10. Consequently, the inside diameter of the cup rim 14a is larger than the outside diameter of the screw pot 12.

According to FIG. 5, the screw pot 12 is not guided on the stop 10, but rather on the inside of the cup rim 14a. This takes place in turn by way of a suitable threaded connection.

In the embodiment according to FIG. 6, the positions of the helical spring 8 and the elastomer block 11 are interchangeable, and the helical spring and the elastomer block are connected in parallel. The elastomer block 11 sits with its lower end on the bottom plate 16a of a spring cup 16, which is fastened on the emerging piston rod 4. In contrast, the upper end of the elastomer block 11 is braced against a hat-shaped sleeve-like stop 17, which is fixed in position on the lower section of the outside of the damping cylinder 2.

The bottom plate 16a of the spring cup 16 is securely connected to an upwardly extending cup wall 16b. The cup wall 16b projects beyond the elastomer block 11, where it passes over into a spring seat 16c for the helical spring 8. For this purpose the upper rim of the cup wall 16b is bent downwards in the shape of a U and then passes over again—forming the spring seat 16c—into a guide flange 16d, with which the whole spring cup 16 is mounted in an axially displaceable manner on the outer wall of the damping cylinder 2. The lower end of the helical spring 8 rests against the spring seat 16c, while the upper end is braced against a stop 10, which is securely connected to the damping cylinder 2.

The cup wall 16b is arranged at a distance around the outer contour of the elastomer block 11. A screw pot 12 in turn can be slid into the annular cavity that is produced in this way. The screw pot 12 restricts with more or less intensity the radial expansion options of the elastomer block 11. The screw pot 12 is guided on the inside of the cup wall 16b and is moved upwards and/or downwards in the radial direction by way of an electric servomotor (M) 18 and a gear system 19.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A suspension strut for a wheel of a vehicle, comprising:
a damping cylinder in which a damping piston having an outwardly guided piston rod is displaceable;
a first spring element arranged around the damping cylinder;
a second spring element which is an elastomer block, the elastomer block having a hollow cylinder shape and being arranged around a cylinder wall of the damping cylinder in an axially displaceable manner without any intermediate space and being coupled in series to the first spring element;
a stop element fixed in position on the damping cylinder, wherein a sandwich configuration of the first and second spring element is braced against an external end of the piston rod and the stop element; and
a screw pot movable in an axial direction of the suspension strut over an outer contour of the elastomer blocks.

2. The suspension strut according to claim 1, wherein the first spring element is a helical spring, which is arranged coaxially to an axis of the suspension strut and which rests at a lower end on a spring support, mounted on the piston rod, and strikes at an opposite end against an underside of an axially displaceable spring plate; and
wherein the elastomer block is clamped between an upper side of the spring plate and the stop element.

3. The suspension strut according to claim 2, wherein the fixed position of the stop element is vertically adjustable by an external thread on a cylinder jacket of the damping cylinder.

4. The suspension strut according to claim 1, wherein a spring plate serves as a lower stop for the screw pot.

5. The suspension strut according to claim 2, wherein the spring plate serves as a lower stop for the screw pot.

6. The suspension strut according to claim 3, wherein the spring plate serves as a lower stop for the screw pot.

7. The suspension strut according to claim 2, wherein the spring plate between the first and second spring element is configured with an axially upwards extending cup rim, which at least partially envelops the elastomer block when longitudinally expanding, so as to form a spring cup, which provides a stop that interacts with the screw pot.

8. The suspension strut according to claim 5, wherein the spring plate between the first and second spring element is configured with an axially upwards extending cup rim, which at least partially envelops the elastomer block when longitudinally expanding, so as to form a spring cup, which provides a stop that interacts with the screw pot.

9. The suspension strut according to claim 6, wherein the spring plate between the first and second spring element is configured with an axially upwards extending cup rim, which at least partially envelops the elastomer block when longitudinally expanding, so as to form a spring cup, which provides a stop that interacts with the screw pot.

10. The suspension strut according to claim 7, wherein the stop for the screw pot is vertically adjustable by an external thread on the cup rim.

11. The suspension strut according to claim 7, wherein the cup rim covers an entire length of the elastomer block and is dimensioned such that a cavity for penetration by the screw pot is formed between an inner wall of the cup rim and an outer surface of the elastomer block, and wherein an inner diameter of the cup rim is larger than an outer diameter of the screw pot.

12. The suspension strut according to claim 10, wherein the cup rim covers an entire length of the elastomer block and is dimensioned such that a cavity for penetration by the screw pot is formed between an inner wall of the cup rim and an outer surface of the elastomer block, and wherein an inner diameter of the cup rim is larger than an outer diameter of the screw pot.

13. The suspension strut according to claim 2, wherein the screw pot is lowerable over the elastomer block via a threaded connection on an outer surface of the stop element.

14. The suspension strut according to claim 11, wherein the screw pot is lowerable over the elastomer block via a threaded connection on an outer surface of the stop element.

15. The suspension strut according to claim 11, wherein the screw pot is guided by a threaded connection on an inner surface of the cup rim.

16. The suspension strut according to claim 1, wherein:
the elastomer block rests at an upper end against a stop, which is fixed in position on the damping cylinder and is braced at a lower end against a spring cup, which is connected to the piston rod; and
the spring cup has an upwards extending cup wall, which runs coaxially to the suspension strut and which envelops at a distance the elastomer block and provides a spring seat, which is movable in the axial direction along an exterior of the damping cylinder, for the lower end of the first spring element, which is configured as a coaxially arranged helical spring, where the helical spring strikes with its opposite end against a stop, which is fixed in position on the cylinder, and where the screw pot is guided on the inside of the cup rim.

17. The suspension strut according to claim 16, further comprising a motor operatively configured to move the screw pot.

18. The suspension strut according to claim 1, wherein the suspension strut is a motorcycle suspension strut.

19. The suspension strut according to claim 7, wherein the suspension strut is a motorcycle suspension strut
